(19) United States
(12) Patent Application Publication
(10) Pub. No.: US 2003/0168158 A1
(43) Pub. Date: Sep. 11, 2003

(54) Method of film laminating

(76) Inventor: Takeyoshi Kato, Kawasaki-shi (JP)

Correspondence Address: BIRCH STEWART KOLASCH & BIRCH, PO BOX 747, FALLS CHURCH, VA, 22040-0747, US

(21) Appl. No.: 10/362,191

(22) PCT Filed: Aug. 22, 2001
(86) PCT No.: PCT/JP01/07181

(30) Foreign Application Priority Data
Aug. 22, 2000 (JP) 2000-251098
Sep. 8, 2000 (JP) 2000-272977
Sep. 13, 2000 (JP) 2000-277853

(51) Int. Cl. B32B 31/00

(52) U.S. Cl. 156/247; 156/230

(57) ABSTRACT

A method of film laminating which comprises superposing an adhesive film comprising a base film and a resin composition layer on a circuit board so that the resin composition layer is in contact with at least the pattern-bearing part thereof, pressing the adhesive film against the circuit board with a laminating apparatus having a press plate made of a heat-resistant rubber, and then pressing the resultant structure with a laminating apparatus having a press plate made of a metal; and the method of film laminating in which the adhesive film comprising a base film and formed thereon a resin composition layer having a melt viscosity at 120° C. of 10,000 to 100,000 Pa s is superposed on the circuit board so that the resin composition layer overlies at least the circuit pattern part thereof, and the adhesive film is laminated to the circuit board with a press plate and an underlay plate which has a modulus at 120° C. of 1 to 500 MPa and is disposed between the press plate and the base film of the adhesive film. Thus, a multilayer circuit board is obtained which is excellent in buried-layer state and surface smoothness.

### TECHNICAL FIELD

The present invention relates to a method of laminating a film. More particularly, the present invention relates to a method of laminating a film-shaped adhesive on an internal circuit pattern ,in a manufacturing method of a build-up multilayer printed circuit board in which conductive circuit layers and insulating layers are alternately stacked.

### BACKGROUND ART

A build-up multilayer printed circuit board is manufactured by alternately stacking organic insulating layers on conductive layers of an internal circuit board. As a method of stacking the organic insulating layer on the internal circuit board, a method of superposing an adhesive film including a base film and an organic insulating layer laminated on the surface of the base film on the internal circuit board, and pressing the adhesive film against the internal circuit board by using a vacuum laminating apparatus having a pressing plate capable of applying heat and pressure is known. Hardness is an important property for the pressing plate. Generally, a vacuum laminating apparatus having a pressing plate made of heat-resistant rubber is used (see Japanese Patent Application Laid-open No. 2000-228581, for Example).

However, in the case of laminating the organic insulating layer by using a laminating apparatus having a pressing plate made of heat-resistant rubber, the surface of the organic insulating layer becomes uneven along a circuit pattern of the internal circuit board. If the number of laminated layers is increased by forming a circuit board on such an uneven organic insulating layer, dimensional accuracy of the entire multilayer circuit board is decreased. In particular, in the case where the thickness of a conductor of the circuit is greater than the thickness of the organic insulating layer of the adhesive film, unevenness on the surface is significantly increased.

In order to increase dimensional accuracy, use of a vacuum laminating apparatus having a pressing plate made of a metal such as stainless steel has been proposed. However, in the case of using a pressing plate made of a metal, voids tend to be formed between unevenness in the pattern of the internal circuit board and the adhesive film (specifically, filling properties are decreased). Therefore, it is necessary to increase the pressing time and pressure. However, an increase in the pressing time and pressure results in an increase in the load applied to the organic insulating layer, whereby mechanical strength may be decreased.

Japanese Patent Application Laid-open No. 11-340625 discloses use of an underlay plate made of polyethylene terephthalate or heat-resistant rubber between the internal circuit board and the adhesive film in order to prevent a resin composition layer from flowing from the edge during laminating. However, this Patent Application does not take filling properties of an interconnection pattern of the internal circuit board and flatness after laminating into consideration, whereby filling properties and flatness are insufficient.

Accordingly, an object of the present invention is to solve the above-described problems and to provide a method of laminating a film capable of efficiently producing a build-up multilayer printed circuit board excelling in filling properties of an interconnection pattern during laminating and flatness after laminating and curing.

### DISCLOSURE OF THE INVENTION

The present inventor has conducted extensive studies to achieve the above object. As a result, the present inventor has found that (1) filling properties of an interconnection pattern and flatness of an insulating layer (resin composition layer) can be significantly improved by laminating an adhesive film including a base film and a resin composition layer on an internal circuit board by pressing using a pressing plate made of heat-resistant rubber and a pressing plate made of a metal, and (2) a multilayer circuit board excelling in filling properties of an interconnection pattern and in flatness of a resin composition layer can be obtained by laminating under vacuum an adhesive film including a base film and a resin composition layer having a-specific melt viscosity laminated on the surface of the base film on an internal circuit board by providing an underlay plate having a specific modulus of elasticity between an internal circuit board and the adhesive film. This finding has led to the completion of the present invention..

A first invention of the present invention provides a method of laminating a film comprising: superposing an adhesive film A which includes a base film and a resin composition layer A formed on the surface of the base film on a circuit board so that the resin composition layer A is in contact with at least a pattern of the circuit board; pressing the adhesive film A against the circuit board by using a laminating apparatus including at least one operable pressing plate which is made of heat-resistant rubber and is capable of applying heat and pressure; and pressing the adhesive film A against the circuit board by using a laminating apparatus including at least one operable pressing plate which is made of a metal and is capable of applying heat and pressure.

The method of the first invention preferably comprises: superposing an adhesive film A which includes a base film and a resin composition layer A formed on the surface of the base film on a circuit board so that the resin composition layer A is in contact with at least a pattern of the circuit board; pressing the adhesive film A against the circuit board by using a laminating apparatus including at least one operable pressing plate which is made of heat-resistant rubber and is capable of applying heat and pressure; removing the base film from the adhesive film A; superposing an adhesive film B which includes a base film and a resin composition layer B formed on the surface of the base film on the adhesive film A so that the resin composition layer B is in contact with the resin composition layer A; and pressing the adhesive film B against the resin composition layer A by using a laminating apparatus including at least one operable pressing plate which is made of a metal and is capable of applying heat and pressure.

In the first invention, the pressing using the laminating apparatus including the pressing plate made of heat-resistant rubber is preferably performed at a temperature of 70-150° C. and a pressure of 0.05-0.9 MPa, and the pressing using the laminating apparatus including the pressing plate made of a metal is preferably performed at a temperature of 70-170° C. and a pressure of 0.1-5 MPa.

A second invention of the present invention provides a method of laminating a film in a vacuum lamination method of an adhesive film in which a resin composition layer of an adhesive film including a base film and a resin composition layer having a melt viscosity at 120° C. of 10,000 to 100,000 Pa·s laminated on the base film is laminated on at least a circuit pattern of a circuit board under vacuum by using a vacuum laminating apparatus including at least one operable pressing plate capable of applying heat and pressure, the method comprising installing an underlay plate having a modulus of elasticity at 120° C. of 1-500 MPa between the pressing plate and the upper side of the base film of the adhesive film when laminating the resin composition layer of the adhesive film-on at least the circuit pattern of the circuit board.

In the first and second inventions, it is preferable to use an adhesive film including a resin composition layer in a B stage as the adhesive film.

According to the first invention, a multilayer circuit board excelling in filling properties and surface flatness can be obtained even if the thermal bonding time is decreased. The resulting multilayer circuit board excels in filling properties of a circuit having an interconnection pattern of which a conductive layer has a large thickness and in surface flatness. Therefore, the multilayer circuit board is suitably used for minute and multi-functional electronic equipment.

According to the second invention, a multilayer circuit board extremely excellent in filling properties of the interconnection pattern and surface flatness of the resin composition layer can be obtained by using the underlay plate having a specific modulus of elasticity between the pressing plate and the adhesive film when laminating the adhesive film including the base film and the resin composition layer on the internal circuit board under vacuum.

### BEST MODE FOR CARRYING OUT THE INVENTION

An adhesive film A or B used in the first invention includes a base film and a resin composition layer A or B laminated on the surface of the base film.

There are no specific limitations to the base film. As Examples of the base film, a resin film, metal foil, and the like can be given. As the resin film, a thermoplastic resin film may be usually used. As specific Examples of the thermoplastic resin film, a polypropylene film, polyethylene film, polybutene film, polypentene film, polyvinyl chloride, film, polycarbonate film, polyethylene terephthalate film, polyethylene naphthalate film, polyallylate film, nylon film, ethylene-vinyl acetate copolymer film, ethylene-ethyl acrylate copolymer film, acrylic resin film, and the like can be given. Of these, a polyester film such as a polyethylene terephthalate film or a polyethylene naphthalate film is preferable from the viewpoint of heat resistance, chemical resistance, removability after laminating, and the like.

As Examples of the metal foil, copper foil, aluminum foil, nickel foil, chromium foil, gold foil, silver foil, and the like can be given. Of these, copper foil, in particular electrolytic copper foil or rolled copper foil is preferable from the viewpoint of excellent conductivity and low cost.

There are no specific limitations to the thickness of the base film. The thickness of the base film is usually 1-200 μm, preferably 3-100 μm, and still more preferably 10-50 μm from the viewpoint of workability and the like.

There are no specific limitations to the modulus of elasticity of the base film. The modulus of elasticity of the base film measured by using a viscoelasticity measuring instrument (“DSSM6100” manufactured by Seiko Instruments Inc., for Example) is usually l00-15,000MPa, preferably, 000-10,000 MPa, and still more preferably 3,000-8,000 MPa. If the modulus of elasticity of the base film is within this range, delamination resistance during handling, removability of the base film after laminating, filling properties of an interconnection pattern, and flatness of the resin composition layer are extremely well balanced.

The charged voltage (absolute value) of the base film is 500 V or less, preferably 200 V or less, and still more preferably 100 V or less.

The resin composition layer is laminated on the base film by using a conventional curable resin composition.

The curable resin composition usually contains a resin and a curing agent. As Examples of the resin which makes up the curable resin composition, an epoxy resin, phenol resin, acrylic resin, polyimide resin, polyamide resin, polyisocyanate resin, polyester resin, polyphenyl ether resin, alicyclic olefin polymer, and the like can be given. Of these, a resin containing a cyclic structure (hereinafter may be referred to as “cyclic-structure-containing resin”) is preferable, because such a resin has low dielectric properties, low hygroscopicity, and excellent heat resistance.

The cyclic-structure-containing resin may have a cyclic structure in the main chain and/or the side chain. Use of a resin having a cyclic structure in the main chain is preferable from the viewpoint of heat resistance, low dielectric properties, and the like. As Examples of the cyclic structure, an aromatic cyclic structure, an alicyclic structure, and the like can be given. As the cyclic structure, a monocyclic ring, polycyclic ring, condensed polycyclic ring, crosslinked polycyclic ring, polycyclic ring including these rings in combination, and the like can be given. There are no specific limitations to the number of carbon atoms which makeup the cyclic structure. The number of carbon atoms is usually 4-30, preferably 5-20, and still more preferably 5-15.

As specific Examples of the cyclic-structure-containing resin, a cyclic-structure-containing epoxy resin, cyclic-structure-containing acrylic resin, cyclic-structure-containing polyimide resin, cyclic-structure-containing polyamide resin, cyclic-structure-containing polyisocyanate resin, cyclic-structure-containing polyester resin, polyphenylene ether resin, benzocyclobutene resin, polynorbornene resin, and the like can be given. Of these, a cyclic-structure-containing epoxy resin, polyphenylene ether resin, benzocyclobutene resin, polynorbornene resin, and the like are preferable. Use of a polynorbornene resin is particularly preferable.

There are no specific limitations to the curing agent. As Examples of the curing agent, an ionic curing agent, a radical curing agent, and a curing agent having both ionic and radical properties, and the like can be given. Of these, an ionic curing agent is preferable from the viewpoint of insulation resistance, heat resistance, chemical resistance, and miscibility with an alicyclic olefin polymer.

A curing accelerator or a curing auxiliary agent may be added to the curable resin composition in order to accelerate the curing reaction.

As a curable resin composition using a cyclic-structure-containing epoxy resin, a composition disclosed in Japanese Patent Application Laid-open No. 11-1547 and the like can be given. As a curable resin composition using a polyphenylene ether resin, a composition disclosed in Japanese Patent Application Laid-open No. 9-290481 and the like can be given. As a curable resin composition using a benzocyclobutene resin, a composition disclosed in Japanese Patent Application Laid-open No. 11-16883 and the like can be given. As a curable resin composition using a polynorbornene resin, a composition disclosed in W098/56011 and the like can be given.

There are no specific limitations to the dielectric constant of a cured product obtained by curing the curable resin composition used in the present invention. The dielectric constant of the cured product measured at 1 MHz according to JIS C6481 is usually four or less, preferably 3.5 or less, and still more preferably three or less.

The water absorption of the cured product obtained by curing the curable resin composition used in the present invention measured according to JIS C6481 is usually 0.5% or less, preferably 0.3% or less, and still more preferably 0.1% or less.

In the present invention, there are no specific limitations to the melt viscosity at 120° C. of the curable resin composition laminated on the base film before curing. The melt viscosity of the curable resin composition A of the adhesive film A measured by using a dynamic viscoelasticity measuring instrument (“RDA-II” manufactured by Rheometric Scientific Inc.) is usually 1,000-100,000 Pa·s, preferably 5,000-80,000 Pa·s, and still more preferably 10,000-30,000 Pa·s. The melt viscosity of the curable resin composition B of the adhesive film B is usually 10,000-200,000 Pa·s, preferably 15,000-100,000 Pa·s, and still more preferably 20,000-50,000 Pa·s. If the melt viscosity at 120° C. of the curable resin composition is too small, flatness of the surface of the resin composition layer may be insufficient. Moreover, the curable resin composition may flow out during pressing, whereby the pressing plate may be stained, for Example. If the melt viscosity is too great, filling properties of the interconnection pattern and flatness may be insufficient.

The thickness of the resin composition layers of the adhesive films A and B is usually 10-200 μm, preferably 15-150 μm, and still more preferably 20-100 μm. In the case of laminating the adhesive film A on the adhesive film B, the thickness of the resin composition layer of the adhesive film A is preferably equal to or greater than the thickness of the resin composition layer of the adhesive film B. In this case, the thickness of the resin composition layers of the adhesive films A and B is preferably smaller than the thickness of the conductive layer of the circuit board. In more detail, the thickness of the resin composition layers is preferably 30 μm or less.

The area of the base film may be the same as the area of the resin composition layer. However, since the base film is removed after laminating the adhesive film on an internal circuit board, the base film preferably has an area a little greater than the area of the resin composition layer.

As a method of laminating the curable resin composition layer on the base film, (1) a method of superposing the curable resin composition formed in the shape of a film on the base film, and causing the composition to adhere to the base film by applying pressure, and (2) a method of laminating the curable resin composition layer on the base film by using a solution casting method, a melt casting method, or the like can be given. Use of the method (2) is usually preferable. In the solution casting method, a solution or a dispersion liquid of the curable resin composition is applied to the base film, and the solvent is removed by drying.

The solution or dispersion liquid of the curable resin composition is prepared by dissolving or dispersing the curable resin composition in an appropriate solvent. As Examples of the solvent used to prepare the solution or dispersion liquid, an aromatic hydrocarbon solvent such as toluene, xylene, ethylbenzene, and trimethylbenzene; an aliphatic hydrocarbon solvent such as n-pentane, n-hexane, and n-heptane; an alicyclic hydrocarbon solvent such as cyclopentane and cyclohexane; a halogenated hydrocarbon solvent such as chlorobenzene, dichldrobenzene, and trichlorobenzene; a ketone solvent such as methyl ethyl ketone, methyl isobutyl ketone, cyclopentanone, and cyclohexanone; and the like can be given. These solvents may be used either individually or in combination of two or more.

Of these, use of a mixed solvent obtained by mixing a nonpolar solvent such as an aromatic hydrocarbon solvent or an alicyclic hydrocarbon solvent with a polar solvent such as a ketone solvent is preferable, because such a mixed solvent excels in filling properties of minute interconnects and does not cause bubbles or the like to be formed. The mixing ratio by weight of the nonpolar solvent to the polar solvent may be appropriately selected. The mixing ratio is usually 5:95 to 95:05, preferably 10:90 to 90:10, and still more preferably 20:80 to 80:20.

The amount of solvent is appropriately selected depending on the purpose of use. The amount of solvent is determined so that the solid content of the solution or the dispersion liquid of the curable resin composition is usually 5-70 wt %, preferably 10-65 wt %, and still more preferably 20-60 wt %.

As a method of applying the solution or the dispersion liquid of the curable resin composition to the base film, a dip coating method, roll coating method, curtain coating method, die coating method, slit coating method, and the like can be given. The conditions for removal of the solvent by drying are appropriately selected depending on the type of solvent. The drying temperature is usually 20-300° C., and preferably 30-200° C. The drying time is usually 30 seconds to one hour, and preferably one minute to 30 minutes.

It is preferable that the resin composition layer be in a B stage state. The resin composition layer in the B stage can be obtained by appropriately selecting the drying conditions.

The adhesive film of the present invention is preferably prepared by performing an operation of irradiating the base film with soft X-rays, an operation of allowing the base film to come in contact with an alcohol or a surfactant, and an operation of laminating the curable resin composition layer on the base film. These operations are preferably performed in a clean room in which the amount of minute particles is small. The degree of cleanness of the clean room is usually class 10,000 or less, preferably class 1000 or less, and particularly preferably class 500 or less.

The adhesive film formed of the resin composition layer which is solid at room temperature and the base film may be wound in the shape of a roll and stored after optionally laminating a protective film on the side of the resin composition layer opposite to the base film.

Either one side or each side of the circuit board on which the resin composition layer of the adhesive film is laminated may be patterned. In the case where each side of the circuit board is patterned, the resin composition layer of the adhesive film formed of the base film and the resin composition layer can be laminated on each side of the circuit board at the same time by using two sheets of the adhesive films.

There are no specific limitations to the thickness of the conductive layer of the circuit board. The thickness of the conductive layer is usually 1-400 μm, preferably 10-200 μm, and still more preferably 30-100 μm.

In the first invention, the adhesive film A is superposed on the circuit board so that the resin composition layer of the adhesive film A is in contact with at least the pattern of the circuit board. The adhesive film A and the circuit board are then positioned. The adhesive film A is pressed against the circuit board by using a laminating apparatus including at least one operable pressing plate which is made of heat-resistant rubber and is capable of applying heat and pressure. The adhesive film A is then pressed against the circuit board by using a laminating apparatus including at least one operable pressing plate which is made of a metal and is capable of applying heat and pressure.

It suffices that the laminating apparatus have a pressing plate capable of applying heat and pressure. The press mechanism of the laminating apparatus may be a mechanism in which one pressing plate is operated, or a mechanism in which a pair of pressing plates is operated. The pressing plate may be either secured to the laminating apparatus or removable. As specific Examples of the laminating apparatus, commercially available vacuum laminating apparatuses such as a vacuum applicator manufactured by Morton International Inc., a vacuum press machine manufactured by Meiki Co., Ltd., and a vacuum laminator manufactured by OPTEK Inc. can be given.

In the pressing step using the pressing plate made of heat-resistant rubber, the positioned adhesive film A and circuit board are pressed from the side of the base film of the adhesive film A (hereinafter maybe called, “primary pressing”) The primary pressing temperature is usually 70-150° C., and preferably 80-130° C. The primary pressing pressure is usually 0.05-0.9MPa, and preferably 0.1-0.7 MPa. The primary pressing time is usually about 1-120 seconds. The press atmosphere is preferably set at a normal pressure or less in order to increase adhesion between the adhesive film A and the circuit board. The atmosphere is usually reduced to 100 kPa to 1 Pa, and preferably 40 kPa to 1 Pa.

In the pressing step using the pressing plate made of a metal, the adhesive film A is pressed against the circuit board after the primary pressing (hereinafter may be called “secondary pressing”). The secondary pressing temperature is usually 110-170° C., and preferably 120-150° C. The secondary pressing pressure is usually 0.1-5 MPa, and preferably 0.5-3 MPa. The secondary pressing time is usually about 1-120seconds. The atmosphere during pressing is preferably set at a normal pressure or less in order to increase adhesion between the adhesive film and the circuit board. The atmosphere is usually reduced to 100 kPa to 1 Pa, and preferably 40 kPa to 1 Pa.

The pressing plate made of a metal used in the pressing step using the pressing plate made of a metal is not limited to a pressing plate secured to the laminating apparatus. For Example, in a laminating apparatus provided with a pressing plate made of heat-resistant rubber, the adhesive film may be pressed against the circuit board while interposing a metal plate such as a stainless steel plate between the pressing plate made of heat-resistant rubber and the adhesive film.

In a preferred embodiment of the present invention, the base film of the adhesive film A subjected to the primary pressing is removed in the pressing step using the pressing plate made of a metal. The adhesive film B is superposed on the resin composition-layer A and pressed against the resin composition layer A. The secondary pressing temperature in the case of laminating the adhesive film B is usually 70-150° C., and preferably 80-130° C.

In the present invention, it is preferable that the pressing time in the step using the pressing plate made of heat-resistant rubber be almost the same as the pressing time in the step using the pressing plate made of a metal. A wait time when shifting from the step using the pressing plate made of heat-resistant rubber to the step using the pressing plate made of a metal is eliminated by making the pressing time uniform, whereby productivity can be increased.

The second invention is a method of laminating a film in a vacuum lamination method of an adhesive film in which a resin composition layer of an adhesive film including a base film and a resin composition layer having a melt viscosity at 120° C. of 10,000 to 100,000 Pa·s laminated on the base film is laminated on at least a circuit pattern of a circuit board under vacuum by using a vacuum laminating apparatus including at least one operable pressing plate capable of applying heat and pressure, the method comprising installing an underlay plate having a modulus of elasticity at 120° C. of 1-500 MPa between the pressing plate and the upper side of the base film of the adhesive film when laminating the resin composition layer of the adhesive film on at least the circuit pattern of the circuit board.

The resin composition layer which makes up the adhesive film used in the second invention is formed of a resin composition which is solid at room temperature, but thermally flowable. There are no specific limitations to the resin composition insofar as the resin composition contains a thermosetting resin composition as a major component, is softened by heating, is capable of forming a film, and satisfies properties required for an interlayer dielectric material such as heat resistance and electrical properties after curing by heating.

The resin composition usually contains a resin and a curing agent. As Examples of the resin which makes up the resin composition, an epoxy resin, acrylic resin, polyimide resin, polyamide resin, polycyanate resin, polyester resin, polyphenylene ether resin, alicyclic olefin polymer, and the like can be given. Of these, a cyclic-structure-containing resin is preferable because such a resin has low dielectric properties, low hygroscopicity, and excellent adhesion. As Examples of the cyclic-structure-containing resin, the resins illustrated for the adhesive films A and B of the first invention can be given. As the cyclic-structure-containing resin, a cyclic-structure-containing epoxy resin, polyphenylene ether resin, benzocyclobutene resin, and polynorbornene resin are preferable. Use of a polynorbornene resin is particularly preferable.

There are no specific limitations to the curing agent. As Examples of the curing agent, the curing agents illustrated for the adhesive films A and B of the first invention can be used. A curing accelerator or a curing auxiliary agent may be added to the resin composition in order to accelerate the curing reaction. As the resin composition using the cyclic-structure-containing resin, the resin compositions illustrated for the adhesive films A and B of the first invention can be used.

In the present invention, an adhesive film including a resin composition layer having a melt viscosity at 120° C. of 10,000-100,000 Pa·s, preferably 15,000-80,000 Pa·s, and still more preferably 2,000-50,000 Pa·s is used. The melt viscosity at 120° C. of the resin composition layer may be measured by using a dynamic viscoelasticity measuring instrument (“RDA-II” manufactured by Rheometric Scientific Inc., for Example). If the melt viscosity at 120° C. of the resin composition is too small, flatness of the surface of the resin layer may be insufficient. Moreover, the resin composition may flow out during laminating, whereby the pressing plate may be stained, for Example. If the melt viscosity is too great, filling properties of the interconnection pattern and flatness may be insufficient.

The thickness of the resin composition layer is usually 10-200 μm, preferably 15-150 μm, and still more preferably 20-100 μm.

As Examples of the base film which makes up the adhesive film, a thermoplastic resin film such as a polyester film including a polyethylene naphthalate film and polyethylene terephthalate film, a polypropylene film, polyethylene film, polycarbonate film, polyallylate film, and nylon film, metal foil such as copper foil and aluminum foil, release paper, and the like can be given. Of these, a polyethylene terephthalate film and a polyethylene naphthalate film are preferable from the viewpoint of heat resistance, chemical resistance, removability after laminating, and the like. The thickness of the base film is usually 1-200 μm, and preferably 10-100 μm. As the base film , a base film subjected to a mud treatment, a corona treatment, a release treatment, or the like may be used.

The adhesive film is basically formed of the resin composition layer and the base film. However, the adhesive film in which a protective film is further provided on the resin composition layer may be used in order to prevent staining during transportation or storage and to maintain quality. The resin composition layer of the adhesive film may be laminated on the base film in a state in which the resin composition layer has the same area as the base film. However, since the base film is usually removed after laminating the adhesive film on the circuit board, it is preferable to use an adhesive film in which the base film has an area a little greater than the resin composition layer from the viewpoint of workability.

As a method of laminating the resin composition layer on the base film, a method of applying resin varnish obtained by dissolving or dispersing the resin composition in a specific organic solvent using the base film, and drying the solvent by heating and/or hot blasting to form a resin composition layer which is in a state in which the resin composition layer is solid at room temperature and can be cured (this state is called “B stage state”) can be given. A method of preparing the resin varnish, a method of applying the resin varnish to the base film, and the like may be the same as in the case of preparing the adhesive films A and B of the first invention.

The adhesive film formed of the normally solid resin composition layer and the base film thus obtained may be wound in the shape of a roll and stored after optionally laminating a protective film on the surface of the resin composition layer.

The feature of the second invention is that an underlay plate having a specific modulus of elasticity is installed between the pressing plate and the upper side of the base film of the adhesive film when laminating the resin composition layer of the adhesive film on at least the circuit pattern on the circuit board by using the vacuum laminating apparatus.

The modulus of elasticity of the underlay plate at 120° C. is 1-500 MPa, preferably 10-300 MPa, and still more preferably 30-100 MPa. The modulus of elasticity of the underlay plate may be measured by using a viscoelasticity measuring instrument (“DSM 6100” manufactured by Seiko Instruments Inc., for Example). In the case of using the underlay plate having a modulus of elasticity within the above range, filling properties of the interconnection pattern and flatness of the properties of the interconnection pattern and flatness of the insulating layer are extremely excellent. If the modulus of elasticity of the underlay plate is too small, surface flatness after curing the resin composition layer may be insufficient. If the modulus of elasticity is too great, filling properties of the interconnection pattern may be insufficient.

There are no specific limitations to the material for the underlay plate insofar as the modulus of elasticity at 120° C. of the material is within the above range. As Examples of the material for the underlay plate, a polyolefin such as polyethylene, polypropylene, polyvinyl chloride, polybutene, and polypentene, a polyamide such as Nylon 66, a polyester such as an ethylene-ethyl acrylate copolymer, ethylene-vinyl acetate copolymer, and polybuthylene terephthalate, a plastic material such as polycarbonate and acrylic resin, and the like can be given. Of these, polyethylene, polypropylene, polyvinyl chloride, and the like are preferable.

The size (surface area) of the underlay plate is preferably equal to or smaller than the surface area of the resin composition layer of the adhesive film. The thickness of the underlay plate is usually 0.01-10 mm, and preferably 0.1-1 mm.

As the circuit board on which the resin composition layer of the adhesive film is laminated, a circuit board similar to that used in the first invention can be used.

The resin composition layer of the adhesive film may be laminated on the patterned internal circuit board under vacuum by using the conventional vacuum laminating apparatus illustrated for the first invention. The press mechanism of the vacuum laminating apparatus may be a mechanism in which one pressing plate is operated, or a mechanism in which a pair of pressing plates is operated. The underlay plate used in the present invention may be either secured to or separated from the pressing plate of the vacuum laminating apparatus.

In the case where the protective film is present on the resin composition layer of the adhesive film, the resin composition layer of the adhesive film is superposed on the circuit board in which the conductive layer is patterned after removing the protective film. The resin composition layer is laminated on the circuit board by applying heat and pressure from the side of the base film located on the outer side of the adhesive film. The heating temperature is usually 120±100° C., preferably 120±60° C., and still more preferably 120+20° C. The bonding pressure is usually 0.01-20MPa, and preferably 0.01-10MPa. The bonding time is usually 30 seconds to five hours, and preferably one minute to three hours. The atmosphere is usually reduced to 100 kPa to 1 Pa, and preferably 40 kPa to 1 Pa.

In the first and second inventions, the resin composition layer is usually cured in an oven after laminating. The curing conditions are appropriately selected depending on the type of the curing agent. The curing temperature is usually 30-400° C., preferably 70-300° C., and still more preferably 100-200° C. The curing time is usually 0.1-5 hours, and preferably 0.5-3 hours. In the case of laminating a film or a sheet with the base film on the internal circuit board, the film or sheet formed of the curable resin composition may be cured by heating without removing the base film. However, the film or sheet formed of the curable resin composition is usually cured by heating after removing the base film.

The methods of laminating a film of the first and second inventions are not limited to application to the case of using an interlayer resin composition layer for a build-up multilayer circuit board. The methods can also be applied to a thermally flowable resin composition layer such as a dry film such as a solder resist.

### EXAMPLES

The present invention is described in more detail by way of Examples and comparative Examples. However, the following Examples should not be construed as limiting the present invention. In the Examples and comparative Examples, “part” refers to “part by weight” unless otherwise indicated.

(1) The molecular weight was measured as a polystyrene-reduced value by gel permeation chromatography (GPC) using toluene as a solvent unless otherwise indicated.

(2) The hydrogenation rate (ratio of the number of moles of hydrogen after hydrogenation to the number of moles of unsaturated bonds in the polymer before hydrogenation), and the carboxyl group content (ratio of the number of moles of carboxyl groups to the total number of monomer units in the polymer) were calculated from measurement results of ¹H-NMR.

(3) The glass transition temperature (Tg) was measured by differential scanning calorimetry (DSC).

(4) The melt viscosity (Eta*) was measured by using an RDA-II manufactured by Rheometric Scientific Inc. After removing the resin composition from the base film, the melt viscosity at 120° C. of the resin composition was measured at a frequency of 0.5 Hz, a temperature of 60-180° C., and a temperature increase rate of 2° C./min.

(5) The modulus of elasticity of an underlay plate was measured by using a nonresonant forced vibration technique and using a dynamic viscoelasticity measuring instrument (“DMS 6100” manufactured by Seiko Instruments Inc.). The underlay plate was adjusted to 20 mm×5 mm and heated from 50° C. to 160° C. at a temperature increase rate of 2° C./min. while maintaining the measurement frequency at 1 Hz. The storage modulus of elasticity at 120° C. was evaluated.

(6) The takt time was indicated as a processing time for one board. Since the primary pressing and the secondary pressing can be performed in parallel, the time required for either the primary pressing or the secondary pressing longer than the time required for the other was taken as the takt time. In the case of processing a plurality of boards at the same time, the takt time was indicated as a value obtained by dividing the total processing time by the number of processed boards.

(7) Filling properties during interconnection were evaluated by cutting a circuit board and observing the presence or absence of voids using a scanning electron microscope. A case where no voids were observed for 100 interconnects was evaluated as “⊚”, a case where the number of voids was 1-3 was evaluated as “◯”, a case where the number of voids was 4-6 was evaluated as “Δ”, and a case where the number of voids was 7 or more was evaluated as “×”.

(8) Occurrence of bubbles during laminating was evaluated by confirming the presence or absence of bubbles by naked eye observation of a cured product layer of the circuit board from the upper side. A case where no bubbles were observed in a 100 mm area was evaluated as “◯” a case where the number of bubbles was 1-5 was evaluated as “Δ”, and a case where the number of bubbles was 6-10 was evaluated as “×”.

(9) Surface flatness of the cured product was evaluated by cutting a circuit board with an interconnect thickness of 18 μm, and measuring the thickness of the cured product layer using a scanning electron microscope. A case where the difference between the thickest part and the thinnest part was 0 μm or more but less than 2 μm was evaluated as “⊚”, a case where the difference was 2 μm or more but less than 3 μm was evaluated as “◯”, a case where the difference was 3 μm or more but less than 8 μm was evaluated as “Δ”, and a case where the difference was 8 μm or more was evaluated as “×”.

(10) The thickness of the cured resin layer on a conductive layer was measured by cutting a circuit board and observing the circuit board using a scanning electron microscope.

Preparation Example 1

### (Preparation of Hydrogenated Product of Ring-Opening Polymer)

50 mol % of tetracyclododecene (TCD) and 50 mol % of 8-methyltetracyclododecene (MTD) were subjected to ring-opening polymerization, and hydrogenated so that the hydrogenation rate was 99% by using a method disclosed in Japanese Patent Application Laid-open No. 4-363312 to obtain a hydrogenated product of a TCD/MTD ring-opening copolymer with a number average molecular weight (Mn) of 31,200, weight average molecular weight (Mw) of 55,800, and Tg of 158° C.

28 parts of the hydrogenated product of the ring-opening copolymer, 12 parts of maleic anhydride, and 3 parts of dicumyl peroxide were dissolved in 130 parts of tert-butylbenzene. The mixture was reacted at 140° C. for six hours. The resulting reaction solution was poured into 300 parts of methanol to coagulate the reaction product. The coagulated maleic acid modified polymer was dried at 100° C. for 20 hours under vacuum to obtain a hydrogenated product of a maleic acid modified ring-opening polymer. The Mn and Mw of the hydrogenated product of the polymer were respectively 33,200 and 68,300. The Tg of the hydrogenated product was 170° C. The maleic acid group content of the hydrogenated product was 25 mol %.

### Example 1

100 parts of the hydrogenated product of the maleic acid modified ring-opening polymer, 53.2 parts of diallyl monoglycidyl isocyanate, 5.42 parts of dicumyl peroxide, and 30 parts of polymelamine phosphate (“MPP-C” manufactured by Sanwa Chemical Co., Ltd.) were dissolved in a mixed solvent of 170 parts of xylene and 110 parts of cyclopentanone to obtain varnish of a curable resin composition.

The varnish was filtered through a precision filter made of Teflon with a pore diameter of 10 μm, and applied to a 300 mm×300 mm polyethylene naphthalate film with a thickness of 75 μm (“Teonex” manufactured by Teijin Ltd.) by using a die coater. The varnish was dried at 100° C. for 600 seconds in a nitrogen oven to obtain a dry film with a base film in which the thickness of the resin was 40 μm. The melt viscosity of the resin composition on the base film was 25,000 Pa·s.

An internal circuit board with a thickness of 0.8 mm, on which a conductive interconnect layer of which the interconnect width and the distance between the interconnects were 165 μm and the thickness of the conductive layer was 18 μm was formed, and through which plated through holes with a diameter of 0.2 mm were formed, was provided. Impurities on the board were removed by washing with a 1 mol/l sodium hydroxide aqueous solution. The board was then washed with water and dried.

The dry film with a base film was superposed on each side of the internal circuit board after washing so that the base film was on the outside and the curable resin composition layer was on the inside. The dry films were bonded to the internal circuit board by heating at a temperature of 110° C. and a pressure of 0.5 MPa for 60 seconds using a vacuum laminating apparatus having pressing plates made of heat-resistant rubber on top and bottom while reducing the atmosphere to 0.27 kPa (primary pressing). The dry films were then bonded to the internal circuit board by heating at a temperature of 140° C. and a pressure of 1.0 MPa for 60 seconds using a vacuum laminating apparatus having pressing plates made of heat-resistant rubber covered with a pressing plate made of stainless steel on top and bottom while reducing the atmosphere to 0.27 kPa (secondary pressing). After removing only the base film, the internal circuit board was allowed to stand in a nitrogen oven at 150° C. for 120 minutes to form an electrical insulating layer on the internal circuit board. The evaluation results for this circuit board are shown in Table 1.

### Example 2

A circuit board was obtained in the same manner as in Example 1 except for changing the pressure and the heating temperature in the primary pressing step to 0.1 MPa and 100° C., respectively. The evaluation results for this circuit board are shown in Table 1.

### Example 3

A circuit board was obtained in the same manner as in Example 1 except for using varnish of a curable resin composition obtained by dissolving 100 parts of the hydrogenated product of the maleic acid modified ring-opening polymer, 50 parts of a brominated bisphenol A epoxy resin (“Araldite AER8049” manufactured by Asahi-Ciba Ltd.), 0.1 part of 1-benzyl-2-phenylimidazole, 10 parts of antimony pentoxide, and 5 parts of a silicone resin (“Tospearl 120” manufactured by GE Toshiba Silicone Co., Ltd.) in a mixed solvent of 135 parts of xylene and 90 parts of cyclopentanone. The melt viscosity of the resin composition on the base film was 38,000 Pa·s. The evaluation -results for this circuit board are shown in Table 1.

### Example 4

A circuit board was obtained in the same manner as in Example 3 except for changing the amount of the brominated bisphenol A epoxy resin to 100 parts. The melt viscosity of the resin composition on the base film was 11,000 mPa·s. The evaluation results for this circuit board are shown in Table 1.

### Example 5

A circuit board was obtained in the same manner as in Example 1 except that 10 base films and nine stainless steel plates were alternately layered, and the 10 base films were bonded by heating at a temperature of 130° C. and a pressure of 2 MPa for 20 minutes using a vacuum laminating apparatus while reducing the atmosphere to 1.3 kPa in the secondary pressing. The evaluation results for this circuit board are shown in Table 1.

### Comparative Example 1

A circuit board was obtained in the same manner as in Example 1 except that the secondary pressing using the vacuum laminating apparatus was not performed. The evaluation results for this circuit board are shown in Table 1.

### Comparative Example 2

A circuit board was obtained in the same manner as in Example 1 except that the primary pressing was not performed and the secondary pressing using the stainless steel plate was performed at a temperature of 120° C. and a pressure of 1.0 MPa for 60 seconds while reducing the atmosphere to 0.27 kPa. The evaluation results for this circuit board are shown in Table 1.

### Comparative Example 3

A circuit board was obtained in the same manner as in Comparative Example 2 except. that the secondary pressing was performed while interposing a polypropylene sheet with a thickness of 0.1 mm instead of the stainless steel plate. The evaluation results for this circuit board are shown in Table 1.

### Comparative Example 4

A circuit board was obtained in the same manner as in Comparative Example 3 except for changing the thermal bonding time to 600 seconds. The evaluation results for this circuit board are shown in Table 1. It was found that the pressurization time must be increased in order to improve filling properties. It was also found that flatness was barely changed or improved even if the pressurization time was increased.

### Example 6

A circuit board was obtained in the same manner as in Example 1 except for using varnish obtained by using a method given below instead of the varnish used in Example 1.

8-Ethyl-tetracyclo[4.4.0.1^{2,5}.1^{7, 10}]-dodec-3-ene was subjected to ring-opening polymerization, and hydrogenated to obtain a hydrogenated polymer with a number average molecular weight (Mn) of 31,200, weight average molecular weight (Mw) of 55,800, and Tg of about 140° C. The hydrogenation rate of the resulting polymer was 99% or more.

28 parts of the resulting hydrogenated polymer, 10 parts of maleic anhydride, and 3 parts of dicumyl peroxide were dissolved in 130 parts of tert-butylbenzene. The mixture was reacted at 140° C. for six hours.

The reaction product was coagulated by pouring the reaction solution into 300 parts of methanol to obtain a maleic acid modified hydrogenated polymer. The maleic acid modified hydrogenated polymer was dried at 100° C. for 20 hours under vacuum. The Mn and Mw of the maleic acid modified hydrogenated polymer were respectively 33,200 and 68,300. The Tg of the maleic acid modified hydrogenated polymer was 170° C. The maleic acid group content was 25 mol %.

100 parts of the hydrogenated product of the maleic acid modified ring-opening polymer, 50 parts of 1,3-diallyl-5-glycidyl isocyanurate, 5 parts of dicumyl peroxide, and 30 parts of polymelamine phosphate (“MPP-C” manufactured by Sanwa Chemical Co., Ltd.) were dissolved in a mixed solvent of 170 parts of xylene and 110 parts of cyclopentanone to obtain varnish of a curable resin composition. The varnish was filtered through a precision filter made of Teflon with a pore diameter of 10 μm. This varnish was used in this Example. The melt viscosity of the resin composition on the base film was 24,000 Pa·s. The evaluation results are shown in Table 1.

TABLE 1

| | | | | |
|---|---|---|---|---|
| | | Presence or | | |
| Takt time | Filling | absence of | | Overall |
| (sec) | properties | bubbles | Flatness | evaluation |

| | | | | | |
|---|---|---|---|---|---|
| Example 1 | 60 | ⊚ | ◯ | ⊚ | ⊚ |
| Example 2 | 60 | ⊚ | ◯ | ⊚ | ⊚ |
| Example 3 | 60 | ◯ | ◯ | ◯ | ◯ |
| Example 4 | 60 | ⊚ | ◯ | ⊚ | ⊚ |
| Example 5 | 120 | ⊚ | ◯ | ⊚ | |
| Example 6 | 60 | ⊚ | ◯ | ⊚ | ⊚ |
| Comparative | 60 | ⊚ | ◯ | X | Δ |
| Example 1 | | | | | |
| Comparative | 60 | X | X | ⊚ | X |
| Example 2 | | | | | |
| Comparative | 60 | Δ | ◯ | ◯ | Δ |
| Example 3 | | | | | |
| Comparative | 600 | ⊚ | ◯ | ◯ | Δ |
| Example 4 | | | | | |

As shown in Table 1, a circuit board obtained by performing the pressing step using the pressing plate made of heat-resistant rubber (primary pressing) and the subsequent pressing step using the pressing plate made of stainless steel (secondary pressing) exhibited excellent filling properties and surface flatness. In particular, a circuit board obtained by using a resin composition having a melt viscosity of 10,000 to 30,000 Pa·s excelled in balance between flatness and filling properties (Examples 1 and 6). On the contrary, a circuit board obtained by performing only the pressing step using the pressing plate made of heat-resistant rubber exhibited inferior surface flatness, because unevenness was formed along the pattern of the internal circuit board (Comparative Example 1). A circuit board obtained by performing only the pressing step using the pressing plate made of a metal exhibited inferior filling properties, whereby problems such as occurrence of bubbles occurred (Comparative Example 2). In the case where the sheet such as a polypropylene film was interposed, thermal bonding for a long period of time was necessary in order to obtain desired filling properties and flatness (Comparative Examples 3 and 4).

### Example 7

The varnish used in Example 6 was applied to a 300 mm×300 mm polyethylene naphthalate film with a thickness of 75 μm (“Teonex” manufactured by Teijin Ltd.) by using a die coater. The varnish was dried at 100° C. for 600 seconds in a nitrogen oven to obtain dry films A and B with a base film in which the thickness of the resin was 25 μm. The melt viscosity of resin compositions A and B on the base films was 25,000 Pa·s.

An internal circuit board with a thickness of 0.8 mm, on which a conductive interconnect layer having a pattern of which the removal rate of the conductive layer was 60%, an interconnect width and a distance between the interconnects of 165 μm, and the thickness of the conductive layer was 50 μm was formed, and through which plated through holes with a diameter of 0.3 mm were formed, was washed with a 1 mol/l sodium hydroxide aqueous solution to remove impurities on the board. The board was then washed with water and dried.

The dry film A with a base film was superposed on each side of the internal circuit board after washing so that the base film was on the outside and the curable resin composition layer was on the inside. The dry film A was bonded to the internal circuit board by heating at a temperature of 110° C. and a pressure Of 0.5 MPa for 60 seconds using a vacuum laminating apparatus having pressing plates made of heat-resistant rubber on top and bottom while reducing the atmosphere to 0.27 kPa (primary pressing). After removing the base film from the dry film A, the dry film B with a base film was superposed on the dry film A. The dry films A and B were then bonded by heating at a temperature of 130° C. and a pressure of 0.5 MPa for 60 seconds using a vacuum laminating apparatus having pressing plates made of heat-resistant rubber covered with a pressing plate made of stainless steel on top and bottom while reducing the atmosphere to 0.27 kPa (secondary pressing) . After removing the base film from the dry film B, the internal circuit board was allowed to stand in a nitrogen oven at 150° C. for 120 minutes to form an electrical insulating layer on the internal circuit board. The evaluation results for this circuit board are shown in Table 2.

### Example 8

A circuit board was obtained in the same manner as in Example 7 except for changing the thickness of the resin of the dry film A with a base film to 35 μm and the thickness of the resin of the dry film B with a base film to 15 μm. The evaluation results for this circuit board are shown in Table 2.

### Example 9

A circuit board was obtained in the same manner as in Example 7 except for using the varnish of the curable resin composition used in Example 3. The melt viscosity of the resin compositions A and B on the base films was 38,000 Pa·s. The thickness of the resin was 25 μm. The evaluation results are shown in Table 2.

### Example 10

A circuit board was obtained in the same manner as in Example 7 except for the following conditions. Specifically, the dry film A with a base film was obtained by using the varnish used in Example 6. The melt viscosity of the resin composition A was 25,000 Pa·s and the thickness of the resin was 45 μm. The dry film B with a base film was obtained by using the varnish used in Example 3. The melt viscosity of the resin composition B was 38,000 Pa·s and the thickness of the resin was 15 μm. The evaluation results for this circuit board are shown in Table 2.

### Comparative Example 5

A circuit board was obtained in the same manner as in Example 7 except that a dry film with a base film in which the thickness of the resin was 50 μm was used, and the secondary pressing using a vacuum laminating apparatus was not performed. The evaluation results for this circuit board are shown in Table 2.

### Comparative Example 6

A circuit board was obtained in the same manner as in Example 7 except that a dry film with a base film in which the thickness of the resin was 50 μm was used, and the secondary pressing was performed at a temperature of 120° C. and a pressure of 1.0 MPa for 60 seconds while reducing the atmosphere to 200.27 kPa without performing the primary pressing. The evaluation results for this circuit board are shown in Table 2.

TABLE 2

| | Thickness | | | | |
|---|---|---|---|---|---|
| | of resin on | | Presence | | |
| | conductive | Filling | or absence | | Overall |
| | layer (μm) | properties | of bubbles | Flatness | evaluation |
| Example 7 | 20 | ⊚ | ◯ | ◯ | ◯ |
| Example 8 | 20 | ⊚ | ◯ | ◯ | ◯ |
| Example 9 | 20 | ◯ | ◯ | ⊚ | ◯ |
| Example 10 | 21 | ⊚ | ◯ | ⊚ | ⊚ |
| Comparative | 26 | ⊚ | ⊚ | X | Δ |
| Example 5 | | | | | |
| Comparative | 22 | X | X | ⊚ | X |
| Example 6 | | | | | |

As is clear from Table 2, a circuit board which exhibited superior filling properties of a circuit having an interconnection pattern of which the conductive layer has a large thickness and excelled in surface flatness was obtained by performing the primary pressing and the secondary pressing. Surface flatness and filling properties were particularly well-balanced in the case where the melt viscosity of the resin composition used for the primary pressing was 10,000-30,000 Pa·s, the melt viscosity of the resin composition used for the secondary pressing was 20,000-50,000 Pa·s, and the thickness of the resin layer used for the primary pressing was equal to or greater than the thickness of the resin layer used for the secondary pressing (Example 10).

On the contrary, a circuit board obtained by performing only the pressing step using the pressing plate made of heat-resistant rubber exhibited inferior surface flatness because unevenness was formed along the pattern of the internal circuit board (Comparative Example 5). A circuit board obtained by performing only the pressing step using the pressing plate made of a metal exhibited inferior filling properties, whereby problems such as occurrence of bubbles occurred (Comparative Example 6).

### Example 11

100 parts of the hydrogenated product of the maleic acid modified ring-opening polymer obtained in Preparation Example 1, 50 parts of a brominated bisphenol A epoxy resin (“Araldite AER8049” manufactured by Asahi-Ciba Ltd.), 0.1 part of 1-benzyl-2-phenylimidazole, 10 parts of antimony pentoxide, and 5 parts of a silicone resin (“Tospearl 120” manufactured by GE Toshiba Silicone Co., Ltd.) were dissolved in a mixed solvent of 135 parts of xylene and 90 parts of cyclopentanone to obtain varnish of a curable resin composition.

The varnish was filtered through a precision filter made of Teflon with a pore diameter of 3 μm, and applied to a 300 mm×300 mm polyethylene naphthalate film with a thickness of 75 μm (“Teonex” manufactured by Teijin Ltd.) by using a die coater. The varnish was dried at 120° C. for 210 seconds in a nitrogen oven to obtain a dry film with a base film in which the thickness of the resin was 35 μm. The melt viscosity of the resin. composition on the base film was 25,000 Pa·s.

An internal circuit board with a thickness of 0.8 mm, on which a conductive interconnect layer in which the interconnect width and the distance between the interconnects were 75 μm and the thickness of the, conductive layer was 18 μm was formed, and through which plated through holes with a diameter of 0.2 mm were formed, was washed with a 1 mol/l sodium hydroxide aqueous solution to remove impurities on the board. The board was then washed with water and dried.

The dry film with a base film was superposed on each side of the internal circuit board after the above processing so that the base film was on the outside and the film was on the inside. The dry films were bonded to the internal circuit board by heating at a temperature of 120° C. and a pressure of 5 Kgf/cm² for 10 minutes while reducing the atmosphere to 0.13 kPa by using a vacuum laminating apparatus in which a polyethylene sheet with a thickness of 0..1 mm was used as an underlay plate. After removing only the base film, the internal circuit board was allowed to stand in a nitrogen oven at 180° C. for 60 minutes to form an electrical insulating layer on the internal circuit board. A circuit board in this Example was thus obtained. The modulus of elasticity of the underlay plate used during vacuum laminating, the melt viscosity of the electrical insulating layer of the circuit board, and the evaluation results are shown in Table 3.

### Example 12

A circuit board was obtained in the same manner as in Example 11 except for using a polypropylene sheet with a thickness of 0.1 mm as the underlay plate instead of the polyethylene sheet. The modulus of elasticity of the underlay plate used during vacuum laminating, the melt viscosity of the electrical insulating layer of the circuit board, and the evaluation results are shown in Table 3.

### Example 13

A circuit board was obtained in the same manner as in Example 12 except for changing the amount of the brominated bisphenol A epoxy resin to 100 parts. The modulus of elasticity of the underlay plate used during vacuum laminating, the melt viscosity of the electrical insulating layer of the circuit board, and the evaluation results are shown in Table 3.

### Example 14

A circuit board was obtained in the same manner as in Example 11 except for changing the drying time from 210 seconds to 1,200 seconds when forming the dry film. The modulus of elasticity of the underlay plate used during vacuum laminating, the melt viscosity of the electrical insulating layer of the circuit board, and the evaluation results are shown in Table 3.

### Comparative Example 7

A circuit board was obtained in the same manner as in Example 11 except that the underlay plate was not used. The melt viscosity of the electrical insulating layer of the circuit board and the evaluation results are shown in Table 3.

### Comparative Example 8

A circuit board was obtained in the same manner as in Example 11 except for using a polyethylene terephthalate sheet with a thickness of 0.1 mm as the underlay plate instead of the polyethylene sheet. The modulus of elasticity of the underlay plate used during vacuum laminating, the melt viscosity of the electrical insulating layer of the circuit board, and the evaluation results are shown in Table 3.

### Comparative Example 9

A circuit board was obtained in the same manner as in Example 11 except for using a sheet made of heat-resistant rubber with a thickness of 1 mm as the underlay plate instead of the polyethylene sheet. The modulus of elasticity of the underlay plate used during vacuum laminating, the melt viscosity of the electrical insulating layer of the circuit board, and the evaluation results are shown in Table 3.

### Comparative Example 10

A circuit board was obtained in the same manner as in Example 12 except that the varnish of the curable resin composition was obtained by using 50 parts of diglycidyl ether of aniline (“GAT” manufactured by Nippon Kayaku Co., Ltd.) instead of the brominated bisphenol A epoxy resin. The modulus of elasticity of the underlay plate used during vacuum laminating, the melt viscosity of the electrical insulating layer of the circuit board, and the evaluation results are shown in Table 3. In Table 3, PE, PP, and PET respectively indicate polyethylene, polypropylene, and polyethylene terephthalate.

TABLE 3

| | | | Modulus of | | | |
|---|---|---|---|---|---|---|
| | Melt | Material for | elasticity of | | Presence or | |
| | viscosity | underlay | underlay | Filling | absence of | |
| | (Pa · s) | plate | plate (MPa) | properties | bubbles | Flatness |
| Example 11 | 25000 | FE | 10 | ⊚ | ◯ | ◯ |
| Example 12 | 25000 | PP | 50 | ⊚ | ◯ | ◯ |
| Example 13 | 10500 | PP | 50 | ◯ | ◯ | ◯ |
| Example 14 | 92000 | FE | 10 | ◯ | ◯ | ◯ |
| Comparative | 25000 | None | — | X | X | ◯ |
| Example 7 | | | | | | |
| Comparative | 25000 | PET | 1400 | Δ | Δ | ◯ |
| Examle 8 | | | | | | |
| Comparative | 25000 | Rubber | <1 | ⊚ | ◯ | X |
| Example 9 | | | | | | |
| Comparative | 123000 | PP | 50 | X | X | ◯ |
| Example 10 | | | | | | |

As is clear from Table 3, in the case where an adhesive film having a resin composition layer of which the melt viscosity at 120° C. was 10,000-100,00Pa·s was used, and the adhesive film was laminated while installing an underlay plate of which the modulus of elasticity at 120° C. was 1-500 MPa (Examples 11 to 14), a circuit board which excelled in filling properties, did not show occurrence of bubbles, and excelled in surface flatness was obtained. On the contrary, filling properties were insufficient and occurrence of bubbles was observed in the case where an underlay plate was not used, an underlay plate of which the modulus of elasticity exceeded 500 MPa was used, or an adhesive film having a resin composition layer of which the melt viscosity exceeded 100, 000Pa·s was used (Comparative Examples 7, 8, and 10). In the case where an underlay plate of which the modulus of elasticity was less than 1 MPa was used, although filling properties were excellent and occurrence of bubbles was not observed, flatness was insufficient (Comparative Example 9).

### INDUSTRIAL APPLICABILITY

As described above, according to the first invention, a multilayer circuit board excelling in filling properties and surface flatness can be obtained even if the thermal bonding time is decreased. In particular, since a multilayer circuit board excelling in surface flatness and filling properties of a circuit having an interconnection pattern of which the conductive layer has a large thickness can be obtained, a multilayer circuit board obtained according to the present invention is suitably used for minute and multifunctional electronic equipment.

According to the second invention, a multilayer circuit board excelling in filling properties of an interconnection pattern and in surface flatness of a resin composition layer can be obtained by using an underlay plate having a specific modulus of elasticity between a pressing plate and an adhesive film when laminating under vacuum the adhesive film including a base film and a resin composition layer having a specific melt viscosity on an internal circuit board.

1. A method of laminating a film comprising:
superposing an adhesive film A which includes a base film and a resin composition layer A formed on the surface of the base film on a circuit board so that the resin composition layer A is in contact with at least a pattern of the circuit board,
pressing the adhesive film A against the circuit board by using a laminating apparatus including at least one operable pressing plate which is made of heat-resistant rubber and is capable of applying heat and pressure, and
pressing the adhesive film A against the circuit board by using a laminating apparatus including at least one operable pressing plate which is made of a metal and is capable of applying heat and pressure.

2. A method of laminating a film comprising:
superposing an adhesive film A which includes a base film and a resin composition layer A formed on the surface of the base film on a circuit board so that the resin composition layer A is in contact with at least a pattern of the circuit board,
pressing the adhesive film A against the circuit board by using a laminating apparatus including at least one operable pressing plate which is made of heat-resistant rubber and is capable of applying heat and pressure,
removing the base film from the adhesive film A, superposing an adhesive film B which includes a base film and a resin composition layer B formed on the surface of the base film on the adhesive film A so that the resin composition layer B is in contact with the resin composition layer A, and
pressing the adhesive film B against the resin composition layer A by using a laminating apparatus including at least one operable pressing plate which is made of a metal and is capable of applying heat and pressure.

3. The method of laminating a film according to claim 1 or 2,
wherein the pressing using the laminating apparatus including the pressing plate made of heat-resistant rubber is performed at a temperature of 70-150° C. and a pressure of 0.05-0.9 MPa, and
the pressing using the laminating apparatus including the pressing plate made of a metal is performed at a temperature of 70-170° C. and a pressure of 0.1-5 MPa.

4. The method of laminating a film according to any one of claims 1 to 3, wherein the resin composition layer of the adhesive film A or B is in a B stage state.

5. A method of laminating a film in a vacuum lamination method of an adhesive film in which a resin composition layer of an adhesive film including a base film and a resin composition layer having a melt viscosity at 120° C. of 10,000 to 100,000 Pa·s laminated on the base film is laminated on at least a circuit pattern of a circuit board under vacuum by using a vacuum laminating apparatus including at least one operable pressing plate capable of applying heat and pressure, the method comprising:
installing an underlay plate having a modulus of elasticity at 120° C. of 1-500 MPa between the pressing plate and the upper side of the base film of the adhesive film when laminating the resin composition layer of the adhesive film on at least the circuit pattern of the circuit board.

6. The method of laminating a film according to claim 5, wherein the resin composition layer of the adhesive film is in a B stage state.
